(19) United States
(12) Patent Application Publication
(10) Pub. No.: US 2024/0289057 A1
(43) Pub. Date: Aug. 29, 2024

(54) MEMORY SYSTEM

(71) Applicant: Kioxia Corporation, Tokyo (JP)

(72) Inventor: Yoshikazu TAKEYAMA, Fujisawa Kanagawa (JP)

(21) Appl. No.: 18/589,289

(22) Filed: Feb. 27, 2024

(30) Foreign Application Priority Data
Feb. 28, 2023 (JP) 2023-030150

(51) Int. Cl. G06F 3/06

(52) U.S. Cl. CPC G06F 3/0659; G06F 3/0613; G06F 3/0683

(57) ABSTRACT

A memory system includes a first die, a second die, and a controller that controls writing and reading of data to and from the first die and the second die. The first die includes a first nonvolatile memory and a first volatile memory, and the second die includes a second nonvolatile memory and a second volatile memory. The controller includes a third volatile memory and during writing of data into the first die, the controller writes the data, which is stored in the third volatile memory and is to be stored in the first die, to the first volatile memory of the first die and the second volatile memory of the second die in parallel.

### CROSS-REFERENCE TO RELATED APPLICATION(S)

This application is based upon and claims the benefit of priority from Japanese Patent Application No. 2023-030150, filed Feb. 28, 2023, the entire contents of which are incorporated herein by reference.

### FIELD

Embodiments described herein relate generally to a memory system.

### BACKGROUND

In a NAND flash memory, in order to avoid interference between cells, two-stage writing, in which a controller sequentially writes data to target memory cells, and then sequentially rewrites the data to the target memory cells again, is performed. Therefore, the controller needs to store data in a volatile memory (RAM: Random Access Memory) in the controller until the second writing is completed.

In the NAND flash memory, in order to increase a storage capacity, it is common to write multivalued data into one memory cell, and in recent years, a quadruple level cell (QLC), in which data of 4 bits can be written, has become mainstream. In the QLC, since data is written to a large number of memory cells during the period after data has been written to a target memory cell until the data is rewritten to the same memory cell, the required capacity of a volatile memory in the controller increases, which becomes an obstacle to improving the degree of integration.

### DESCRIPTION OF THE DRAWINGS

FIG. 1 is a block diagram showing a schematic configuration of a memory system according to a first embodiment of the present disclosure.

FIG. 2 is a block diagram showing an example of an internal configuration of a die.

FIG. 3 is a circuit diagram showing an example of a NAND array.

FIG. 4 is a diagram illustrating an example of a writing sequence when a program is divided into two stages.

FIG. 5A is a schematic diagram showing a 1st program stage in the memory system according to the first embodiment of the present disclosure.

FIG. 5B is a schematic diagram showing a 2nd program stage in the memory system according to the first embodiment of the present disclosure.

FIG. 6 is a block diagram showing a detailed configuration of the memory system according to the first embodiment of the present disclosure.

FIG. 7 is a diagram illustrating a write operation of a memory system according to a comparative example.

FIG. 8 is a block diagram showing a configuration of a die according to a second embodiment of the present disclosure.

FIG. 9 is a block diagram showing a memory system according to a third embodiment of the present disclosure.

### DETAILED DESCRIPTION

Embodiments provide a memory system that can reduce a capacity of a volatile memory in a controller.

In general, according to one embodiment, there is provided a memory system including a first die, a second die, and a controller configured to control writing and reading of data to and from the first die and the second die. The first die includes a first nonvolatile memory and a first volatile memory that temporarily stores data to be stored in the first nonvolatile memory and data read from the first nonvolatile memory, and the second die includes a second nonvolatile memory and a second volatile memory that temporarily stores data to be stored in the second nonvolatile memory and data read from the second nonvolatile memory. The controller includes a third volatile memory that temporarily stores data to be stored in the first die or the second die and data read from the first die or the second die. During writing of data into the first die, the controller writes the data, which is stored in the third volatile memory and is to be stored in the first die, to the first volatile memory of the first die and the second volatile memory of the second die in parallel.

Hereinafter, embodiments of the present disclosure will be described with reference to the drawings.

### First Embodiment

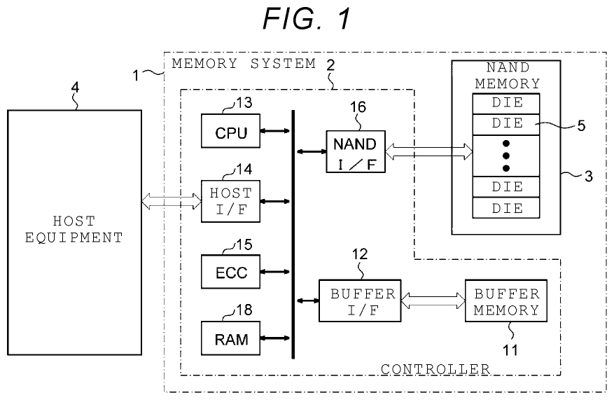

FIG. 1 is a block diagram showing a schematic configuration of a memory system 1 according to a first embodiment of the present disclosure. The memory system 1 of FIG. 1 includes a controller 2 and a NAND flash memory (hereinafter may be referred to as NAND memory) 3. The memory system 1 of FIG. 1 can be connected to host equipment (hereinafter simply referred to as host) 4. The host 4 is, for example, electronic equipment such as a personal computer or a mobile terminal.

The NAND memory 3 is an example of a semiconductor memory device. The NAND memory 3 includes, for example, one or more memory chips, and each memory chip includes a plurality of stacked dies. Each die is a unit cut out from a wafer and singulated into pieces. The controller 2 accesses each of the plurality of dies 5 at individual timings. Access refers to writing, reading, or erasing data.

The controller 2 operates according to a specification in which data of multi-values more than two values can be written into a memory cell by writing the same data multiple times into a nonvolatile memory provided in the die 5. The embodiment mainly describes an example in which the die 5 has a 4-bit/cell (QLC: Quad Level Cell) nonvolatile memory that can store data of 4 bits per memory cell.

The controller 2 is, for example, a system on chip (SoC), and issues read, write, erase instructions, and the like to the NAND memory 3 in response to an instruction from the host 4. The controller 2 also includes, for example, a buffer memory 11, a buffer interface circuit (buffer I/F) 12, a central processing unit (CPU) 13, a host interface circuit (host I/F) 14, an error correction code (ECC) circuit 15, a NAND interface circuit (NAND_I/F) 16, and a random access memory (RAM) 18.

The buffer memory 11 is a volatile memory used as a storage area of the controller

2. The buffer memory 11 is a high-speed volatile memory that temporarily stores write data received from the host 4, for example. The buffer memory 11 can be configured with a static random access memory (SRAM) or a dynamic random access memory (DRAM).

The buffer I/F 12 is connected to the buffer memory 11 and controls communication between the CPU 13 and the buffer memory 11.

The CPU 13 controls the overall operation of the controller 2. The CPU 13 issues a write command in response to a write instruction received from the host 4, for example. Further, the CPU 13 executes various processing for managing a memory space of the NAND memory 3, such as, for example, wear-leveling.

The host I/F 14 is connected to the host 4 via a host bus, and controls the transfer of data, a command, and an address between the controller 2 and the host 4. The host I/F 14 may support communication interface standards such as serial advanced technology attachment (SATA), serial attached SCSI (SAS), and PCI Express (PCIe)®.

The ECC circuit 15 performs error correction processing for data. For example, during a write operation, the ECC circuit 15 may generate a parity based on write data received from the host 4, and add the generated parity to the write data. During a read operation, the ECC circuit 15 may generate a syndrome based on read data received from the NAND memory 3, and detect and correct errors in the read data based on the generated syndrome. Various modifications can be considered for a processing operation of the ECC circuit 15, and the processing operation of the ECC circuit 15 is not limited to any specific processing operation.

The NAND_I/F 16 controls the transfer of data, a command, and an address between the controller 2 and the NAND memory 3, and may independently control each die 5 in the NAND memory 3. The NAND_I/F 16 supports a NAND interface standard.

The RAM 18 is a volatile memory such as a static random access memory (SRAM). The RAM 18 is used as a work area for the CPU 13, and stores, for example, firmware for managing the NAND memory 3, various management tables, and the like.

The CPU 13 accesses the NAND memory 3 according to the command from the host 4. For example, when a command to write to the NAND memory 3 is issued from the host 4 to the controller 2, the CPU 13 in the controller 2 temporarily stores data to be written in the buffer memory 11. The buffer memory 11 has memory capacity for at least a page, which is a unit of writing of the NAND memory 3. The controller 2 writes the data written in the buffer memory 11 into a write target die 5 of the NAND memory 3 multiple times. When a command to read the NAND memory 3 is issued from the host 4 to the controller 2, the CPU 13 reads data in page units from a read target die 5 of the NAND memory 3 and stores the data in the buffer memory 11. The CPU 13 transmits the read data stored in the buffer memory 11 to the host 4 via the host I/F 14.

The ECC circuit 15 encodes the data stored in the buffer memory 11 to generate a code word. Further, the ECC circuit 15 performs error detection on data read from the die 5. When an error is detected, the ECC circuit 15 corrects error if the error can be corrected, or performs predetermined error processing if the error cannot be corrected.

The buffer memory 11 temporarily stores write data from the host 4 before writing the write data into the die 5. Further, the buffer memory 11 temporarily stores data read from the die 5 before transmitting the data read from the die 5 to the host 4. The buffer memory 11 is, for example, a high-speed volatile memory such as a static random access memory (SRAM) or a dynamic random access memory (DRAM). The buffer memory 11 has a faster access speed than a NAND array in the NAND memory 3. As described above, the buffer memory 11 has a memory capacity equal to or larger than a page, which is a unit of writing or reading.

FIG. 1 shows a configuration example in which the controller 2 includes the ECC circuit 15 and the NAND_I/F 16, respectively. The ECC circuit 15 may be incorporated into the NAND_I/F 16. Further, the ECC circuit 15 may be incorporated into the NAND memory 3.

The configuration of the controller 2 shown in FIG. 1 is an example, and various derivative configurations may be adopted. For example, an internal bus 17 may have a divided structure or a hierarchical structure, or additional functional blocks may be incorporated into or connected to the controller 2.

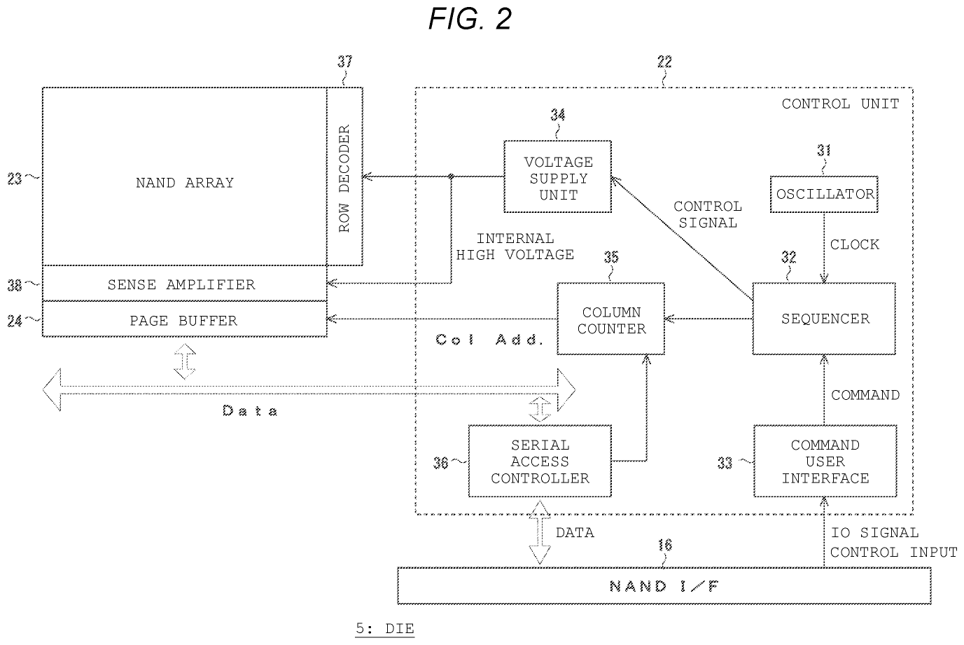

FIG. 2 is a block diagram showing an example of an internal configuration of one die 5 in the NAND memory 3. The die 5 includes a NAND_I/F 16, a control unit 22, a NAND memory cell array (hereinafter simply referred to as a NAND array) 23, and a page buffer 24. The NAND_I/F 16, the control unit 22, the NAND array 23, and the page buffer 24 are formed, for example, on a semiconductor substrate (for example, a silicon substrate) and made into a chip.

The control unit 22 is a circuit that controls an operation of the die 5 based on a command and the like from the controller 2 via the NAND_I/F 16. Specifically, when a write request is input, the control unit 22 controls data requested to be written to be written into a specified address on the NAND array 23. Furthermore, when a read request is input, the control unit 22 controls data requested to be read to be read from the NAND array 23 and to output the data to the controller 2 via the NAND_I/F 16. The page buffer 24 is a buffer that temporarily stores data transferred from the buffer memory 11 of the controller 2 during writing to the NAND array 23, and a buffer that temporarily stores data read from the NAND array 23.

The control unit 22 includes the following circuit components: an oscillator 31, a sequencer 32, a command user interface 33, a voltage supply unit 34, a column counter 35, and a serial access controller 36. The NAND array 23 includes a row decoder 37 and a sense amplifier 38.

The NAND_I/F 16 is a circuit for transmitting and receiving an IO signal and a control input to and from the controller 2. The command user interface 33 acquires a command and an address among the command, the address, and data received from the controller 2 via an IO signal line based on the control input. The command user interface 33 delivers the acquired command and address to the sequencer 32. A type of signal transmitted and received on the IO signal line may be selected. Furthermore, various variations can be applied to a method of transmitting and receiving an address, a command, data, and various control signals, and the method is not limited to the matters described herein.

The oscillator 31 is a circuit that generates a clock. The clock generated by the oscillator 31 is supplied to the sequencer 32 and the like. The sequencer 32 is a state machine driven by the clock supplied from the oscillator 31. The sequencer 32 executes control such as access to the NAND array 23. For example, the sequencer 32 issues an instruction for controlling various internal voltages, operation timings, and the like in response to the command received from the command user interface 33. The sequencer 32 supplies a block address and a page address provided in the address received from the command user interface 33 to the row decoder 37. Furthermore, the sequencer 32 supplies a column address provided in the address received from the command user interface 33 to the column counter 35.

The voltage supply unit 34 is a circuit that generates various internal voltages to be supplied to a word line and various internal voltages to be supplied to a bit line, and supplies the internal voltages to the row decoder 37 and the sense amplifier 38. During a program operation or a read operation, the column counter 35 uses the column address supplied from the sequencer 32 as a head address and advances the column addresses sequentially according to the signal supplied from the serial access controller 36.

The page buffer 24 temporarily stores write target data transferred from the buffer memory 11 of the controller 2, as described later. The write target data stored in the page buffer 24 is written in page units into the NAND array 23 of the write target die 5. Further, the page buffer 24 temporarily stores data read in page units from the NAND array 23 of the read target die 5. The page buffer 24 is configured with, for example, SRAM, but may also be configured with DRAM.

During a program operation, the serial access controller 36 stores data serially received from the NAND_I/F 16 for each bit of the IO signal line in the page buffer 24. Further, during a read operation, the serial access controller 36 sends data serially received from the page buffer 24 for each bit of the IO signal line to the NAND_I/F 16.

During the program operation and the read operation, the row decoder 37 decodes a block address and a page address and selects a word line corresponding to a page, which becomes an access target page, provided in an access destination block. Each row decoder 37 applies an appropriate voltage to a selected word line and a non-selected word line.

During the program operation, the sense amplifier 38 transfers the corresponding data stored in the page buffer 24 to a memory cell transistor. Furthermore, during the read operation, the sense amplifier 38 senses data read from the selected word line to the bit line, and stores the obtained data in the page buffer 24. The data stored in the page buffer 24 is sent to the controller 2 via the serial access controller 36 and the NAND_I/F 16.

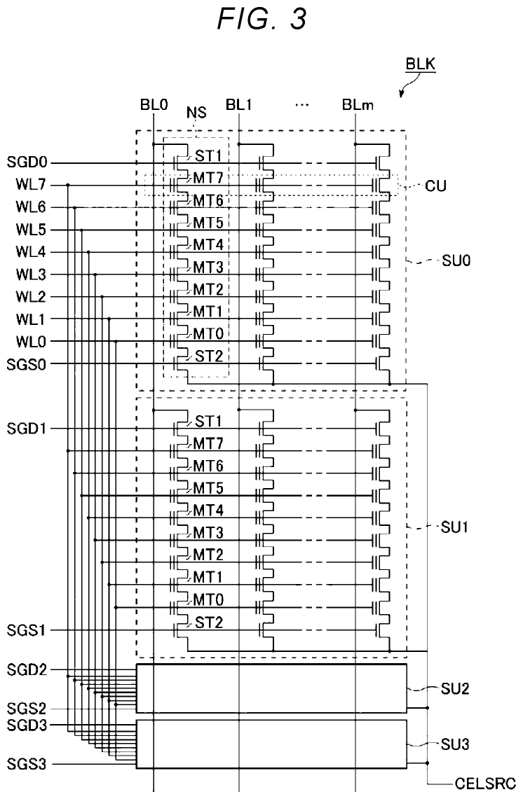

FIG. 3 is a circuit diagram showing an example of the NAND array 23. FIG. 3 shows a circuit configuration of one block that is a part of the NAND array 23. One block is a unit of erase in the NAND memory 3. A block BLK includes, for example, four string units SU0 to SU3.

Each string unit SU includes a plurality of NAND strings NS respectively associated with bit lines BL0 to BLm. The NAND string NS includes, for example, memory cell transistors MT0 to MT7 and select transistors ST1 and ST2.

The memory cell transistor MT includes a control gate and a charge storage layer, and stores data in a nonvolatile manner. Each of the select transistors ST1 and ST2 is used to select the string unit SU during various operations.

In each NAND string NS, the memory cell transistors MT0 to MT7 are connected in series. The select transistor ST1 is connected between one end of the memory cell transistors MT0 to MT7 connected in series and an associated bit line BL. A drain of the select transistor ST2 is connected to the other end of the memory cell transistors MT0 to MT7 connected in series. A source line CELSRC and a well line CPWELL (not shown) are connected to a source of the select transistor ST2.

In the same block BLK, gates of a plurality of select transistors ST1 provided in the string units SU0 to SU3 are connected to select gate lines SGD0 to SGD3, respectively. Control gates of the plurality of memory cell transistors MT0 to MT7 are commonly connected to word lines WL0 to WL7, respectively. The gates of the plurality of select transistors ST2 are connected to select gate lines SGS0 to SGS3, respectively.

The bit lines BL0 to BLm are shared among a plurality of blocks BLK. The same bit line BL is connected to the NAND strings NS corresponding to the same column address. Each of word lines WL0 to WL7 is provided for each block BLK. Each of the source line CELSRC and the well line CPWELL (not shown) is shared among a plurality of blocks BLK, for example.

A set of a plurality of memory cell transistors MT connected to a common word line WL in one string unit SU is referred, for example, as a cell unit CU. For example, a storage capacity of the cell unit CU including the memory cell transistors MT each storing 1-bit data is defined as “1 page data”. The cell unit CU can have a storage capacity of 2 page data or more depending on the number of bits of data stored in each memory cell transistor MT.

The circuit configuration of the NAND memory cell array 23 described above is merely an example, and is not limited thereto. For example, the number of string units SU provided in each block BLK can be designed to be any number. The numbers of memory cell transistors MT and select transistors ST1 and ST2 provided in each NAND string NS can be designed to be any number, respectively.

As described above, data of memory cells (memory cell transistors MT) in the same block BLK are collectively erased. On the other hand, reading and writing of data are performed in a unit of memory cell group configured with a plurality of memory cells connected to the same word line, and one memory cell group MG constitutes one page. In the embodiment, it is assumed that data of multi-values more than two values is written into one memory cell, and in this case, one page is configured with a plurality of hierarchical pages. For example, in the case of QLC, one memory cell group has a data amount of 4 bits×the number of bits, and is provided with a total of four hierarchical pages of a Lower page, a Middle page, an Upper page, and a Top page. In this specification, a plurality of hierarchical pages corresponding to one memory cell group may be collectively referred to simply as a page. Furthermore, in this specification, a page, which is a unit of writing and reading, is sometimes referred to as a memory area.

More specifically, the controller 2 performs writing in units of all NAND strings NS connected to one word line WLi in one string unit. A unit of data amount programmed by the controller 2 is 4 bits×the number of bit lines.

During the read operation and the program operation, according to a physical address, one word line WLi and one select gate line are selected and a memory cell group is selected. In this specification, writing data to the memory cell group is referred to as programming.

In a 4-bit/Cell NAND memory, interference between cells is greater than in a 1-bit/Cell or 2-bit/Cell NAND memory. For this reason, in the recent generation of NAND memory, which has become increasingly miniaturized, in order to reduce the interference between cells, a program operation is performed in which charges are gradually injected into floating gates of memory cells in two or more stages. As the program operation performed in two or more stages, for example, Foggy-Fine programming or LM-Foggy-Fine programming is known.

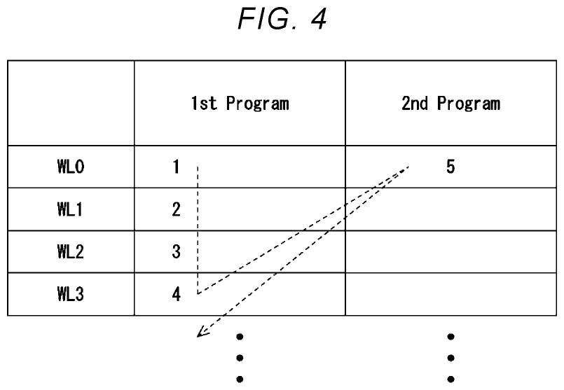

FIG. 4 is a diagram showing an example of a writing sequence when programming is performed in two stages. The controller 2 first performs a first stage write (1st Program) to a word line WL0. That is, the controller 2 performs the 1st Program to the page of the memory cell group connected to the word line WL0. The controller 2 then similarly performs the 1st Program to the page connected to a word line WL1 adjacent to the word line WL0. The controller 2 also sequentially performs the 1st Program to the pages connected to word lines WL2 and WL3.

After the 1st Program for the page connected to the word line WL3, the controller 2 performs a second stage write (2nd Program) to the page connected to the word line WL0. After that, the controller 2 sequentially performs the 1st Program for the page connected to a word line adjacent to the word line WL3, and the 2nd Program for the page connected to the word line for which the 1st Program is completed (for example, word line WL1).

As described above, the controller 2 of the embodiment performs at least two programs (1st Program and 2nd Program) for each page (memory area). Furthermore, between the 1st Program and the 2nd Program for one page, the 1st Program for adjacent pages is performed multiple times. Furthermore, between the 1st Program and 2nd Program for one page, the 2nd Program may be performed for the page for which the 1st Program is completed.

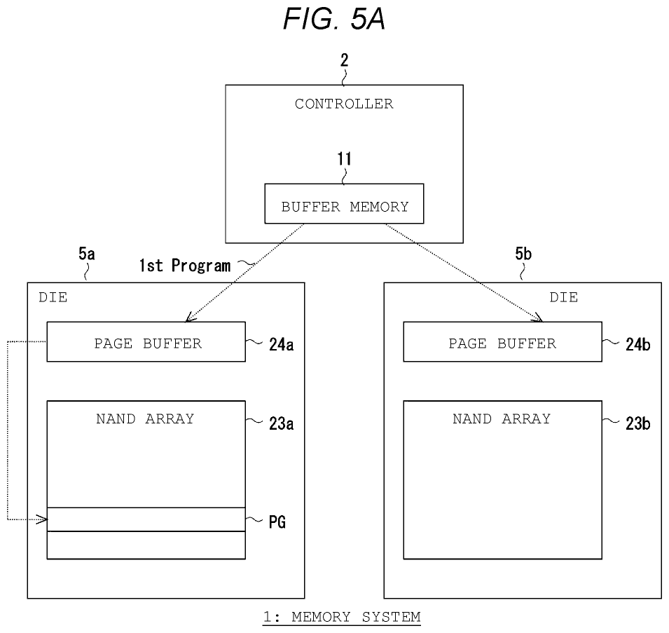

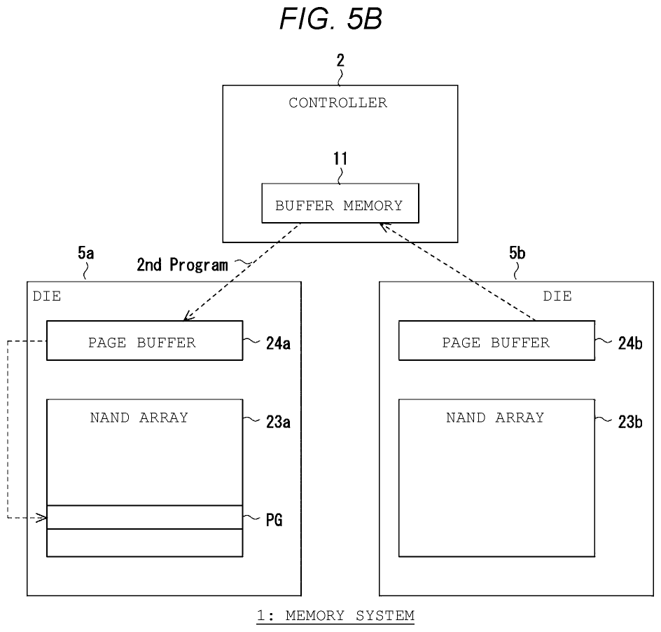

FIGS. 5A and 5B are diagrams showing write processing to the die 5 in the memory system 1 according to the first embodiment of the present disclosure. The controller 2 according to the first embodiment transfers write data stored in the buffer memory 11 to a write target die (first die) 5a and a non-write target die (second die) 5b in the NAND memory 3.

The write target die 5a includes a NAND array (first nonvolatile memory) 23a and a page buffer (first volatile memory) 24a. The non-write target die 5b includes a NAND array (second nonvolatile memory) 23b and a page buffer (second volatile memory) 24b. Data is written to the NAND arrays 23a and 23b in page units.

FIG. 5A shows the 1st Program to the write target die 5a. When receiving a write instruction from the host 4, the controller 2 temporarily stores write data in the buffer memory 11 in page units. After that, the controller 2 transfers the data stored in the buffer memory 11 to the page buffer 24a of the write target die 5a and the page buffer 24b of the non-write target die 5b in parallel. After the write data stored in the buffer memory 11 is transferred to the page buffer 24a in the write target die 5a and the page buffer 24b in the non-write target die 5b, the controller 2 can erase the data in the buffer memory 11. With this, the controller 2 can use the buffer memory 11 to store write data for other pages.

Subsequently, the controller 2 transmits a predetermined write command to the write target die 5a. The die 5a writes the data in the page buffer 24a into the corresponding page (for example, page PG in FIG. 5A) in the NAND array 23a in accordance with the write command. This is the 1st Program of the corresponding page. When the 1st Program of the corresponding page is completed, the data stored in the page buffer 24a of the write target die 5a can be erased. Thus, the die 5a can use the page buffer 24a for writing data for other pages. Meanwhile, since the controller 2 does not transmit a predetermined write command to the non-write target die 5b, the page buffer 24b of the non-write target die 5b continues to store data even after the 1st Program to the write target die 5a is completed.

As shown in FIG. 4, after the 1st Program to a certain page is completed and before the 2nd Program to that page is performed, the 1st Program to a plurality of other pages is performed. The data of the buffer memory 11 in the controller 2 and the data of the page buffer 24a in the write target die 5a are updated to write data to another page for each 1st program to other pages. The page buffer 24b in the non-write target die 5b continues to store write data even while 1st Program to another page is being performed.

As shown in FIG. 5A, when transferring write data from the buffer memory 11 to the page buffer 24a of the write target die 5a during the 1st Program, the controller 2 also transfers the same write data to the page buffer 24b of the non-write target die 5b. After that, even after the data is written from the page buffer 24a of the write target die 5a to the corresponding page of the NAND array 23a, the page buffer 24b of the non-write target die 5b continues to store the write data, thus the write data stored in the buffer memory 11 and the page buffer 24a can be erased, and the buffer memory 11 and the page buffer 24a can be used for writing data in other pages and the like.

FIG. 5B shows the 2nd Program of the page PG for which the 1st Program was performed in FIG. 5A. The controller 2 reads the data transferred in FIG. 5A from the page buffer 24b in the non-write target die 5b and writes the data into the buffer memory 11. The controller 2 transfers the data of the buffer memory 11 to the page buffer 24a in the die 5. After that, the controller 2 transmits a predetermined write command to the die 5. The die 5 writes the data in the page buffer 24a to the corresponding page according to the write command.

As shown in FIGS. 5A and 5B, the controller 2 not only stores the write data to the write target die 5a in the page buffer 24a of the write target die 5a, but also stores the write data in the page buffer 24b of the non-write target die 5b in parallel. After that, after writing the write data stored in the page buffer 24a of the write target die 5a to the corresponding page of the NAND array 23a, the write data in the buffer memory 11 and the page buffer 24a can be erased, and the buffer memory 11 and the page buffer 24a can be used to store write data in other pages. On the other hand, the write data in the page buffer 24b of the non-write target die 5b is stored as it is. After that, when performing the 2nd program to the corresponding page of the write target die 5a, the write data is transferred from the page buffer 24b of the non-write target die 5b to the buffer memory 11 of the controller 2. After that, the write data is transferred from the buffer memory 11 to the page buffer 24a of the write target die 5a, and the 2nd Program is performed on the corresponding page. With this, since the buffer memory 11 of the controller 2 and the page buffer 24a of the write target die 5a can erase the written data when the 1st Program of the corresponding page of the write target die Sa is finished, and the buffer memory 11 and the page buffer 24a can be used for writing data into other pages, the storage capacities of the buffer memory 11 and the page buffer 24a can be reduced.

Although FIGS. 5A and 5B show an example in which the write operation to the die 5 is completed in operations of two stages including 1st Program and 2nd Program, the memory system 1 according to the first embodiment is also applicable to a case where the write operation is performed three or more stages. The storage capacity of the buffer memory 11 can be reduced by continuing to store write data in the page buffer 24b of the non-write target die 5b until three or more write operations are completed.

The controller 2 checks the status information recording whether or not the write data is normally written from the page buffer 24a of the write target die 5a into the NAND array 23a, and if the status information is pass, the controller 2 determines that the data is written normally and can erase the written data of the buffer memory 11. Furthermore, in the memory system 1 according to the embodiment, write data is written into the page buffer 24b of the non-write target die 5b. Therefore, even if the status information is fail, the controller 2 can use the write data of the page buffer 24b to rewrite the write data to the page buffer 24a of the write target die 5a. That is, the controller 2 can erase the write data in the buffer memory 11 even if the status information is fail. Therefore, after writing the write data to the page buffer 24a of the write target die 5a and the page buffer 24b of the non-write target die 5b, the controller 2 of the embodiment can erase the write data of the buffer memory 11 without checking the status information. Therefore, a period for storing write data in the buffer memory 11 can be shortened, and the buffer memory 11 can be used effectively.

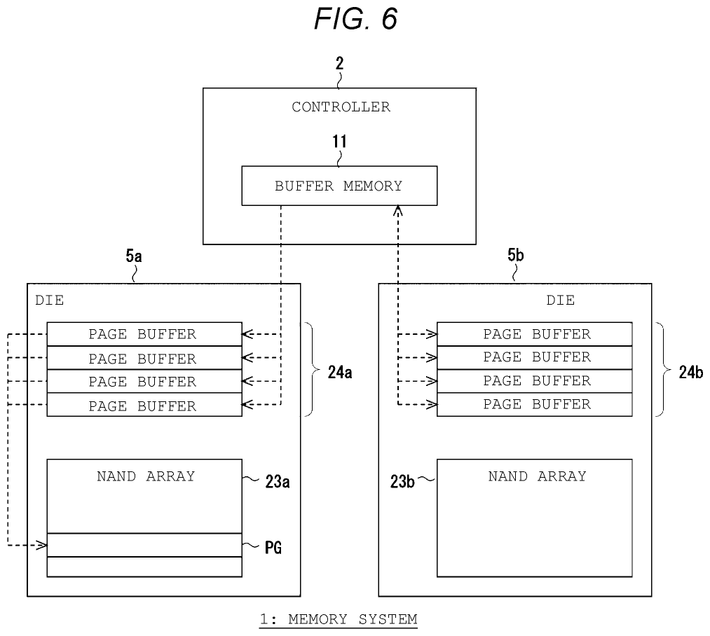

A 4-bit/cell NAND memory usually includes a plurality of page buffers. FIG. 6 is a block diagram showing a detailed configuration of the memory system 1 according to the first embodiment of the present disclosure. For example, one page of each die 5 (5a, 5b) in the NAND memory 3 in FIG. 6 has four hierarchical pages (Lower page, Middle page, Upper page, and Top page). In this case, each die 5 is provided with a page buffer for each of the four hierarchical pages. Each die 5 may be provided with an extra page buffer in addition to the page buffer for each hierarchical page.

The controller 2 temporarily stores write data from the host 4 in the buffer memory 11, and transfers the write data stored in the buffer memory 11 to the page buffer 24a of the write target die 5a. For example, if the buffer memory 11 only has the storage capacity for one hierarchical page, the buffer memory 11 divides write data for four hierarchical pages into four parts and sequentially transfers the divided four parts of write data to four page buffers 24a of the write target die 5a. In parallel with this, the write data is sequentially transferred from the buffer memory 11 to four page buffers 24b of the non-write target die 5b.

The controller 2 sends a write command to the die 5a after the write data of all hierarchical pages are transferred to the page buffers 24a. The write target die 5a writes the write data of all page buffers to a corresponding page PG in parallel according to the write command.

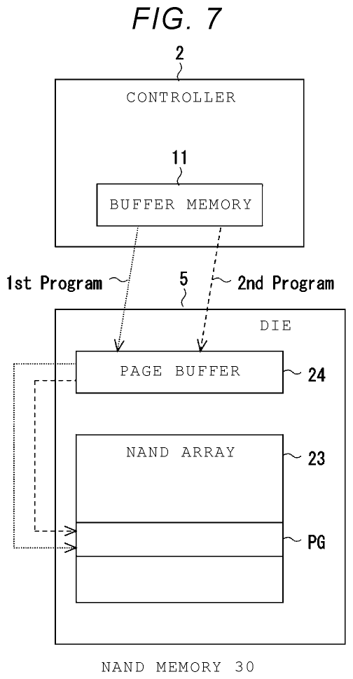

FIG. 7 is a diagram illustrating a write operation of a NAND memory 30 according to a comparative example. In FIG. 7, write data for the 1st Program is transferred from the buffer memory 11 of the controller 2 to the page buffer 24 of the write target die 5a, and then the write data stored in the page buffer 24 is written to the corresponding page of the NAND array 23. As shown in FIG. 4, after performing the 1st Program to a certain page and before performing the 2nd Program to that page, the 1st Program (or 2nd Program) to a plurality of other pages is performed. Therefore, in the comparative example of FIG. 7, the buffer memory 11 should continue to store write data during the period after the 1st Program to a certain page is performed and until the 2nd Program is completed. Therefore, the buffer memory 11 should continue to store a plurality of pages of write data simultaneously, which increases the storage capacity of the buffer memory 11.

In contrast to the NAND memory 30 of the comparative example, in the memory system 1 according to the first embodiment, since write data is transferred from the buffer memory 11 to the page buffer 24a of the write target die 5a and the page buffer 24b of the non-write target die 5b in parallel and the write data continues to be stored in the page buffer 24b until the 2nd Program to the corresponding page is completed. Therefore, even if the write data is erased from the buffer memory 11, since the write data is transferred from the page buffer 24b to the buffer memory 11 during the 2nd Program and the 2nd Program can be performed, the storage capacity of the buffer memory 11 can be reduced.

### Second Embodiment

A configuration, in which when the die 5 has a plurality of page buffers, the controller 2 can access only some of the page buffers, is considered. In this case, the controller 2 cannot freely access the plurality of page buffers and cannot effectively utilize the plurality of page buffers. The second embodiment is characterized in that when the controller 2 can access only some of the page buffers of the die 5, the storage capacity of the buffer memory 11 of the controller 2 can be reduced, similar to the first embodiment.

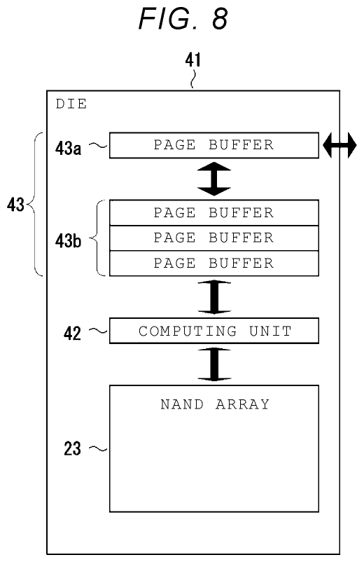

FIG. 8 is a block diagram showing the configuration of a die 41 according to the second embodiment of the present disclosure. The die 41 of FIG. 8 is a die applicable to the dies 5a and 5b of FIGS. 5A and 5B.

The die 41 of FIG. 8 includes a NAND array 23, a plurality of page buffers 43, and a computing unit 42. Among the plurality of page buffers 43, a page buffer 43a can be directly accessed by the controller 2, whereas a page buffer 43b cannot be directly accessed by the controller 2. The page buffers 43a and 43b can transfer data to each other according to a command from the controller 2. The transfer of data between the page buffers 43a and 43b is controlled by the computing unit 42, for example.

The computing unit 42, according to the command from the controller 2, can perform a predetermined computation on data stored in one or a plurality of page buffers among the plurality of page buffers 43 (43a, 43b), and store the result of the computation in another page buffer. The predetermined computation is, for example, bit addition or bit multiplication between two page buffers.

Further, the computing unit 42 can transfer data stored in another page buffer 43b to the page buffer 43a that can be accessed by the controller 2, according to the command from the controller 2. With this, the controller 2 can access substantially any page buffer 43 (43a, 43b) by issuing a command. Further, the controller 2 can also acquire the result of the computation performed by the computing unit 42 of the die 41.

For example, during the 1st Program, the controller 2 specifies which page buffer 43 of the write target die 5a the data should be stored in depending on which of L/M/U/T (Lower page, Middle page, Upper page, Top page) the data should be written into. With this, the computing unit 42 of the write target die 5a transfers the data transferred from the controller 2 to the specific page buffer 43a to another page buffer 43b.

Furthermore, as in the first embodiment, the controller 2 also writes the same data as that of the write target die 5a to the page buffer 43 of the non-write target die 5b. The controller 2 specifies which page buffer 43 of the non-write target die 5b the data should be stored in depending on which of L/M/U/T the data is to be written into. With this, the computing unit 42 of the non-write target die 5b transfers the data transferred from the controller 2 to the specific page buffer 43a to another page buffer 43b.

During the 2nd Program, the controller 2 instructs the transfer of data from the page buffer 43 of the non-write target die 5b to the buffer memory 11, using a command. With this, the computing unit 42 of the non-write target die 5b sequentially transfers the data of the page buffer 43b that cannot be directly accessed by the controller 2 to the page buffer 43a, and transfers the data to the buffer memory 11 via the page buffer 43a, according to the command. In the same way as during the 1st Program, the controller 2 sequentially transfers data transferred from the non-write target die 5b via the page buffer 43a of the write target die 5a.

Thus, in the second embodiment, even if the controller 2 can only access some of the page buffers 43a among the plurality of page buffers 43 of the die 41, data can be transferred to other page buffers 43b via the page buffers 43a, thus, by writing the write data into the page buffer 43 of the non-write target die 5b, as in the first embodiment, a period for storing the write data in the buffer memory 11 of the controller 2 can be shortened and the buffer memory 11 can be used effectively.

### Third Embodiment

The NAND memory 3 is becoming increasingly miniaturized and more integrated, and the number of dies stacked on one NAND memory chip also tends to increase. Furthermore, the storage capacity of a storage device such as SSD equipped with the NAND memory 3 continues to increase. For this reason, in addition to the write target die to which controller 2 performs writing, a large number of non-write target dies exist, and it is desirable to effectively utilize the page buffers provided in these non-write target dies.

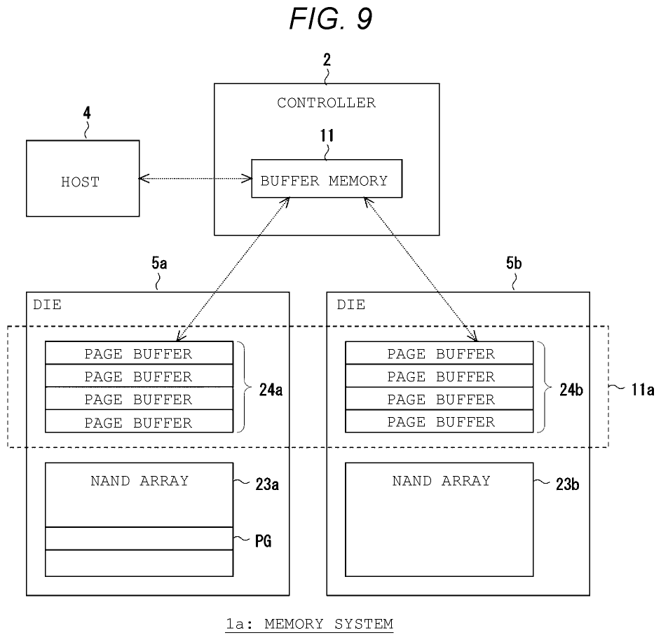

Therefore, the memory system according to the third embodiment is characterized in that the host 4 can use page buffers provided in a plurality of dies as a cache memory. FIG. 9 is a block diagram showing a memory system la according to the third embodiment of the present disclosure. The page buffers 24a and 24b of FIG. 9 constitute a cache memory 11a.

The memory system according to the third embodiment has the functions of the memory system of the first or second embodiment. Specifically, during writing of data into the write target die 5a among the plurality of dies 5, the data of the buffer memory 11 of the controller 2 is transferred to both the page buffer 24a of the write target die 5a and the page buffer 24b of the non-write target die 5b. Further, the write target data stored in the page buffer 24a (24b) is written into the NAND array 23a (23b) at a timing when the controller 2 does not access the die 5a (5b).

When the host 4 issues a read instruction for the write data in a state where the write data is stored in the page buffer 24a or 24b of the write target die 5a or the non-write target die 5b, the controller 2 can read the data stored in the page buffer 24a or 24b at high speed and return the data to the host 4. When the write data is not stored in the page buffer 24a or 24b, the controller 2 reads stored data from the NAND array 23a or 23b.

It is desirable that the dies 5a and 5b evicts the write data whose access frequency from the host 4 does not meet a predetermined criterion from the page buffer 24a or 24b to the NAND arrays 23a and 23b. With this, since the write data whose access frequency exceeds the predetermined criterion is stored in the page buffer 24a and 24b, the controller 2 can read the data stored in the page buffers 24a and 24b faster than reading the write data from the NAND arrays 23a and 23b.

Alternatively, the dies 5a and 5b may write the write data stored in the page buffers 24a and 24b to the NAND arrays 23a and 23b in a First In, First Out (FIFO) manner. When the data for which the read instruction is issued from the host 4 does not exist in the page buffer 24a of the die 5a, the controller 2 may refer to the page buffer 24b of the non-write target die 5b, and read data from the NAND arrays 23a and 23b only when there is no data in the page buffer 24b as well.

Thus, since the memory system la of the third embodiment uses the page buffers 24a and 24b of the dies 5 (5a, 5b) as the cache memory, it is possible to improve the access speed of the NAND memory 3 by the host 4 by effectively utilizing not only the page buffer 24a of the write target die 5a but also the page buffer 24b of the non-write target die 5b.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a first die;
a second die; and
a controller configured to control writing and reading of data to and from the first die and the second die, wherein
the first die includes a first nonvolatile memory and a first volatile memory, and the second die includes a second nonvolatile memory and a second volatile memory, and
the controller includes a third volatile memory, and the controller, during writing of data into the first die, stores the data in the third volatile memory, writes the data, which is stored in the third volatile memory and is to be stored in the first die, to the first volatile memory of the first die and the second volatile memory of the second die in parallel.

2. The memory system according to claim 1, wherein
the first die writes the data written from the third volatile memory to the first volatile memory to the first nonvolatile memory.

3. The memory system according to claim 1, wherein
during writing of multi-bit data to the first nonvolatile memory, the controller controls the first die to write the same multi-bit data into the first nonvolatile memory multiple times.

4. The memory system according to claim 3, wherein
during writing of the same multi-bit data to the first nonvolatile memory a second time or later, the controller reads the multi-bit data from the second volatile memory and writes the multi-bit data read from the second volatile memory to the third volatile memory, and then writes the multi-bit data written to the third volatile memory to the first volatile memory.

5. The memory system according to claim 3, wherein
the same multi-bit data is stored in the second volatile memory until the multiple times of writing to the first nonvolatile memory have completed.

6. The memory system according to claim 5, wherein
the controller stores different data in the third volatile memory after writing the multi-bit data to be written into the first nonvolatile memory into the first volatile memory and the second volatile memory.

7. The memory system according to claim 1, wherein
after writing the data stored in the third volatile memory, which is to be written into the first nonvolatile memory, to the first volatile memory and the second volatile memory, the controller enables the data stored in the third volatile memory to be updated before status information indicating whether or not writing of the data from the first volatile memory to the first nonvolatile memory has completed, indicates completion of writing, and even if the status information indicates a failure of writing.

8. The memory system according to claim 1, wherein
the first nonvolatile memory and the second nonvolatile memory have a plurality of memory areas each of which is a unit of writing and reading, and
the first volatile memory, the second volatile memory, and the third volatile memory have storage capacities corresponding to one or more of the memory areas.

9. The memory system according to claim 8, wherein
the controller enables the data stored in the third volatile memory to be updated after writing data to be written into a predetermined memory area of the first nonvolatile memory from the third volatile memory to the first volatile memory and the second volatile memory.

10. The memory system according to claim 8, wherein
after writing first data stored in the first volatile memory into the predetermined memory area of the first nonvolatile memory a first time, the first die performs an operation of writing other data stored in the first volatile memory after the first volatile memory is updated to store the other data, to a memory area other than a predetermined memory area of the first nonvolatile memory multiple times, and then after the first volatile memory is updated to store the first data, writes the first data stored in the first volatile memory again into the predetermined memory area of the first nonvolatile memory.

11. The memory system according to claim 1, wherein
each of the first volatile memory, the second volatile memory, and the third volatile memory has a plurality of memory areas, and
the controller writes data stored in the plurality of memory areas in the third volatile memory into the first volatile memory and the second volatile memory in parallel.

12. The memory system according to claim 1, wherein
in response to a data read instruction from a host device, the controller reads read target data from the first volatile memory or the second volatile memory when the read target data is stored in the first volatile memory or the second volatile memory, and controls the first die to read the read target data from the first nonvolatile memory or the second die to read the read target data from the second nonvolatile memory when the read target data is not stored in the first volatile memory or the second volatile memory.

13. The memory system according to claim 1, wherein
in response to a data write instruction from a host device, the controller writes write target data into the third volatile memory and then writes the write target data stored in the third volatile memory into the first volatile memory and the second volatile memory in parallel.

14. The memory system according to claim 13, wherein
the controller evicts the write target data stored in the first volatile memory or the second volatile memory and whose access frequency does not meet a predetermined criterion from the first volatile memory to the first nonvolatile memory or from the second volatile memory to the second nonvolatile memory.

15. The memory system according to claim 13, wherein
the data stored in the first volatile memory or the second volatile memory is written from the first volatile memory into the first nonvolatile memory or from the second volatile memory into the second nonvolatile memory during a period when the controller is not accessing the first die or the second die.

16. The memory system according to claim 1, wherein
the first die and the second die each include a sense amplifier and a row decoder.

17. The memory system according to claim 1, wherein
the first volatile memory, the second volatile memory, and the third volatile memory are static random access memories (SRAMs).

18. The memory system according to claim 1, wherein
the first nonvolatile memory and the second nonvolatile memory are NAND flash memories.

19. The memory system according to claim 1, wherein
the memory system comprises a plurality of dies including the first die and the second die,
the plurality of dies are stacked, and
the controller accesses each of the plurality of dies at different timings.

20. A method of performing a write operation to write multi-bit data in a memory system that includes a first die having a first nonvolatile memory and a first volatile memory, a second die having a second nonvolatile memory and a second volatile memory, and a controller having a third volatile memory, that is configured to control writing and reading of data to and from the first die and the second die, said method comprising:
in response to a request to write the multi-bit data in the first die, storing the multi-bit data in the third volatile memory and then writing the multi-bit data stored in the third volatile memory to the first volatile memory and the second volatile memory in parallel.
